(19) United States
(12) Patent Application Publication
(10) Pub. No.: US 2020/0379374 A1
(43) Pub. Date: Dec. 3, 2020

(54) INTERMEDIATE TRANSFER MEMBER, IMAGE FORMING METHOD, AND IMAGE FORMING APPARATUS

(71) Applicant: Konica Minolta, Inc., Tokyo (JP)

(72) Inventors: Akihiro HONYA, Tokyo (JP); Yoshiyasu MATSUMOTO, Tokyo (JP); Akiko KAWAMURA, Tokyo (JP); Shingo FUJIMOTO, Tokyo (JP); Hiroyuki YASUKAWA, Tokyo (JP)

(21) Appl. No.: 15/930,850

(22) Filed: May 13, 2020

(30) Foreign Application Priority Data
May 27, 2019 (JP) 2019-098542

(51) Int. Cl. G03G 15/16

(52) U.S. Cl. CPC G03G 15/162

(57) ABSTRACT

The present invention relates to a single-layer or multilayer intermediate transfer member. The intermediate transfer member has a surface on which an intermediate image is to be formed, the surface containing a resin chemically modified with a hydrophilic functional group.

### CROSS REFERENCE TO RELATED APPLICATIONS

The entire disclosure of Japanese Patent Application No. 2019-098542 filed on May 27, 2019, is incorporated herein by reference in its entirety.

### BACKGROUND

### Technological Field

The present invention relates to an intermediate transfer member, an image forming method, and an image forming apparatus.

### Description of Related Art

With an inkjet method, an image can be simply formed at low cost. Therefore, an inkjet method is applied to various printing fields including various printing, marking, fine-line formation, and special printing for color filters and the like. In particular, an inkjet method enables digital printing without using a plate and therefore is particularly suitable for forming various images in small amounts.

For the inkjet method, an image forming method is known in which an intermediate image is formed on the surface of an intermediate transfer member and then the intermediate image is transferred onto a recording medium.

For intermediate transfer members used in such an image forming method, for example, Japanese Patent Application Laid-Open No. 2004-50449 discloses an intermediate transfer member including a grid-shaped or net-shaped water-repellent portion and hydrophilic portions surrounded by the water-repellent portion inside the grid or net. Japanese Patent Application Laid-Open No. 2004-50449 also discloses that the intermediate transfer member has water repellency and can suppress aggregation of moved ink droplets because ink droplets that have impacted are temporarily fixed in the hydrophilic portions. Japanese Patent Application Laid-Open No. 2004-50449 also discloses that the intermediate transfer member can be produced by a method in which a water repellent is caused to adhere to the surface of a substrate film to impart water repellency to the entire surface and then the water repellent is removed in a certain pattern by laser abrasion or the like to form hydrophilic portions or a method in which a hydrophilic epoxy resin is poured into patterned depressions formed on the surface of a roller, and an epoxy resin in portions other than the depressions is removed to form a water-repellent coating.

Japanese Patent Application Laid-Open No. 2015-42466 and Japanese Patent Application Laid-Open No. 2014-136427 disclose that the intermediate transfer member may be surface-treated by, for example, plasma treatment or corona treatment.

A further increase in the transfer ratio of ink from the intermediate transfer member to the recording medium is required for an intermediate transfer image forming method. From the viewpoint of increasing the transfer ratio, a method has been developed in which a pre-coating liquid is applied onto the intermediate transfer member in advance to form a pre-coating layer, and the pre-coating layer is transferred as a release layer together with the ink.

For example, Japanese Patent Application Laid-Open No. 2013-199114 discloses that, by applying a pre-coating liquid containing a particular siloxane compound to an intermediate transfer member formed of silicone rubber or the like and having a water contact angle of 50° or more and 120° or less, the wettability and releasability of the pre-coating liquid for the intermediate transfer member can be controlled. The intermediate transfer member disclosed in Japanese Patent Application Laid-Open No. 2013-199114 is used for image formation with aqueous inks or solvent-based inks.

According to the findings of the present inventors, in Japanese Patent Application Laid-Open No. 2013-199114, a pre-coating liquid having a surface tension decreased by adding a siloxane compound is used to improve the releasability in image formation with aqueous inks or solvent-based inks. However, when an image is formed using an actinic radiation-curable composition containing, as a liquid component, an actinic radiation-curable compound that is polymerized and cross-linked through irradiation with actinic radiation, the pre-coating liquid disclosed in Japanese Patent Application Laid-Open No. 2013-199114 does not achieve sufficient releasability, and a pre-coating liquid having a higher surface tension needs to be used for image formation.

However, such a pre-coating liquid having a high surface tension cannot sufficiently spread over the surface of the intermediate transfer member formed of rubber, which cannot sufficiently increase the transfer ratio of ink.

In contrast, as disclosed in Japanese Patent Application Laid-Open No. 2015-42466 and Japanese Patent Application Laid-Open No. 2014-136427, when the intermediate transfer member is subjected to surface treatment such as plasma treatment or corona treatment, the pre-coating liquid having a high surface tension is expected to be sufficiently spread over the surface of the intermediate transfer member. However, repeated use of surface treatment such as plasma treatment or corona treatment readily deteriorates the intermediate transfer member. Furthermore, a high-frequency power supply, a discharger, and the like need to be disposed in an image forming apparatus, which poses problems in that the apparatus has a very complicated configuration and a high power consumption.

### SUMMARY

The present invention is based on the above findings. It is an object of the present invention to provide an intermediate transfer member having a surface over which a pre-coating liquid having a high surface tension is sufficiently spread without using plasma treatment, corona treatment, or the like to sufficiently increase the transfer ratio of ink, an image forming method that uses the intermediate transfer member, and an image forming apparatus including the intermediate transfer member.

To achieve at least one of the abovementioned objects, according to an aspect of the present invention, a single-layer or multilayer intermediate transfer member reflecting one aspect of the present invention comprises a surface on which an intermediate image is to be formed, the surface containing a resin chemically modified with a hydrophilic functional group.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view partly illustrating a section of an intermediate transfer member according to one embodiment of the present invention;

FIG. 2 is a flowchart illustrating an image forming method according to one embodiment of the present invention; and

FIG. 3 is a schematic view illustrating an exemplary configuration of an image forming apparatus according to one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

### 1. Intermediate Transfer Member

A first embodiment of the present invention relates to a single-layer or multilayer intermediate transfer member. The intermediate transfer member is an intermediate transfer member used when an image is formed by a method in which an intermediate image is formed on a surface of an intermediate transfer member and the formed intermediate image is transferred onto a recording medium.

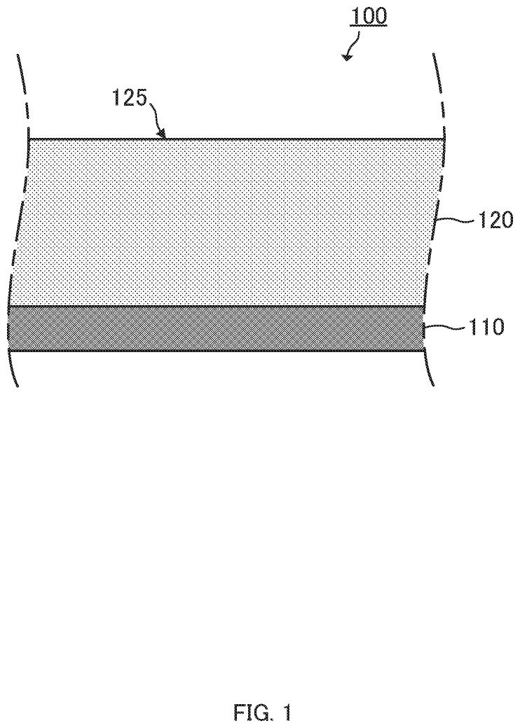

FIG. 1 is a schematic view partly illustrating a section of intermediate transfer member 100 according to this embodiment. Intermediate transfer member 100 includes substrate 110 and elastic layer 120 that is formed on substrate 110 and serves as an uppermost layer of intermediate transfer member 100.

Substrate 110 may be any substrate that can be used for intermediate transfer members, and can be formed of a resin material or a metal material. Examples of the resin material for substrate 110 include resins having a structural unit including a benzene ring, such as aromatic polyimide (PI), aromatic polyimide-imide (PAI), polyphenylene sulfide (PPS), aromatic polyether ether ketone (PEEK), aromatic polycarbonate (PC), and aromatic polyether ketone (PEK); polyvinylidene fluoride (PVDF); and mixtures and copolymers of the foregoing. Examples of the metal material for substrate 110 include metals such as steel, aluminum, and stainless steel.

Substrate 110 may have any thickness such as 30 μm or more and 500 μm or less as long as sufficient strength can be imparted to intermediate transfer member 100.

Elastic layer 120 may be any elastic layer that can be used for intermediate transfer members. Elastic layer 120 readily deforms, which allows intermediate transfer member 100 to readily follow the projections and depressions of a recording medium during transfer. Thus, the intermediate image can be caused to more firmly adhere to a recording medium having a surface with large projections and depressions. Therefore, elastic layer 120 can improve the transferability of an intermediate image and can suppress separation of formed images from the recording medium.

Examples of the material for elastic layer 120 include rubbers such as silicone rubber (SR), chloroprene rubber (CR), nitrile rubber (NBR), and epichlorohydrin rubber (ECO), elastomers, and various resins such as elastic resins. Among them, silicone rubber is preferred from the viewpoint of ease of adjustment of the elasticity of elastic layer 120. Silicone rubber provides a silanol group having high reactivity through activation and therefore has high reactivity with a compound having a hydrophilic functional group described later. Thus, the hydrophilic functional group is easily uniformly fixed on the surface of the intermediate transfer member.

The thickness of elastic layer 120 is, for example, 100 μm or more and 2000 μm or less, preferably 200 μm or more and 1500 μm or less, and more preferably 500 μm or more and 1200 μm or less.

In this embodiment, the surface of elastic layer 120 is a surface on which an intermediate image is to be formed (hereafter, the surface on which an intermediate image is to be formed is also simply referred to as an “intermediate image surface”). Elastic layer 120 has intermediate image surface 125 containing a resin chemically modified with a hydrophilic functional group.

When an image is formed by a method in which an intermediate image formed using an actinic radiation-curable composition on the surface of intermediate transfer member 100 onto which a pre-coating liquid has been applied is transferred onto a recording medium, a liquid having a higher surface tension is desirably used as the pre-coating liquid to improve the releasability of the intermediate image formed of the actinic radiation-curable composition. On the other hand, such a liquid having a high surface tension does not readily spread over the surface of intermediate transfer member 100 (the surface of elastic layer 120) formed of a rubber material. In contrast, when intermediate image surface 125 contains a resin chemically modified with a hydrophilic functional group, the pre-coating liquid having a high surface tension and also having hydrophilicity readily spreads over intermediate image surface 125. Thus, it is believed that the effect of the pre-coating liquid that improves the releasability of the intermediate image is uniformly produced over intermediate image surface 125, which further improves the transferability of the intermediate image.

For example, plasma treatment or corona treatment is also believed to improve the wettability of the pre-coating liquid having a higher surface tension on the surface of the intermediate transfer member. However, the effect of, for example, plasma treatment or corona treatment reduces over time, which requires repetitive treatment. This deteriorates the intermediate transfer member or requires a high-frequency power supply and a discharger disposed in the image forming apparatus, which poses problems in that the apparatus has a very complicated configuration and a high power consumption. In contrast, when the above resin chemically modified with a functional group improves the wettability of the pre-coating liquid having a higher surface tension, the repetitive treatment is not required. Thus, the wettability of the pre-coating liquid having a higher surface tension on the surface of the intermediate transfer member can be improved without deteriorating the intermediate transfer member, complicating the configuration of the apparatus, or increasing the power consumption.

Specifically, for intermediate image surface 125, the difference between the pure water contact angle measured when the pure water contact angle is confirmed to be 50° or less and the pure water contact angle measured by the same method after being left to stand for 10 hours is preferably 20° or less, more preferably 15° or less, and further preferably 10° or less.

The hydrophilic functional group is preferably a polar functional group or an ionic functional group and more preferably an ionic functional group. Examples of the polar functional group include a keto group, an ester group, an ether group (including an oxyalkylene group), an amino group, an amide group, a urethane group, a thiol group, a sulfo group, a sulfoxide group, and a hydroxy group. The polar functional group is preferably a hydrogen-bonding functional group and more preferably a hydroxy group. Among them, the hydrophilic functional group is, for example, preferably an oxyalkylene group having 1 to 3 carbon atoms, an amino group, or a hydroxy group.

Elastic layer 120 may be chemically modified with the hydrophilic functional group by reacting a compound having the hydrophilic functional group with a resin for elastic layer 120. Thus, a sufficient amount of the hydrophilic functional group can be exposed to the surface of elastic layer 120 to sufficiently improve the wettability of the pre-coating liquid.

For example, elastic layer 120 can be chemically modified with the hydrophilic functional group by reacting, with a resin for elastic layer 120, a compound having a hydrophilic group, such as a silane compound having the hydrophilic functional group, an epoxy compound having the hydrophilic functional group, or an isocyanate compound having the hydrophilic functional group. Among them, a silane compound having the hydrophilic functional group is preferred because of its high reactivity with a resin (in particular, silicone rubber).

The compound having the hydrophilic group has a functional group or structure (e.g., silanol group) that forms a bond with a resin and the above hydrophilic functional group. The compound having the hydrophilic group may be a compound having, in its molecule, only one functional group or structure that forms a bond with a resin or may be a compound having two or three functional groups or structures. The compound having the hydrophilic group may further have, in its molecule, an aromatic ring or an oxygen atom or a nitrogen atom serving as a heteroatom.

In other words, intermediate transfer member 100 has, on the intermediate image surface, a structure that has the hydrophilic group and that branches from the main chain of the resin or cross-links the main chain of the resin. The structure having the hydrophilic group may have, in addition to the hydrophilic group, a hydrocarbon group that may include an aromatic ring or an oxygen atom or nitrogen atom serving as a heteroatom.

Intermediate image surface 125 is a surface hydrophilized by exposure of the hydrophilic functional group. Specifically, intermediate image surface 125 is preferably a surface having a pure water contact angle of 50° or less, more preferably a surface having a pure water contact angle of 40° or less, further preferably a surface having a pure water contact angle of 30° or less, still further preferably a surface having a pure water contact angle of 20° or less, and particularly preferably a surface having a pure water contact angle of 15° or less. The lower limit of the pure water contact angle is not particularly limited, and can be set to 10°.

The pure water contact angle may be a value measured at 20° C. in conformity with JIS R 3257(1999).

In the above description, intermediate transfer member 100 is constituted by two layers of substrate 110 and elastic layer 120, and the surface of elastic layer 120 is intermediate image surface 125 containing a resin chemically modified with a hydrophilic functional group. However, the configuration of the present invention is not limited to the above configuration. For example, intermediate transfer member 100 may be a single-layer intermediate transfer member constituted by only substrate 110, and the surface of substrate 110 may be an intermediate image surface containing a resin chemically modified with a hydrophilic functional group. Alternatively, intermediate transfer member 100 may be a multilayer (three or more layers) intermediate transfer member further including another layer on the surface of elastic layer 120, and the surface of the uppermost layer of the intermediate transfer member may be an intermediate image surface containing a resin chemically modified with a hydrophilic functional group.

The intermediate transfer member can be used for a so-called intermediate transfer image forming method in which an intermediate image formed using an actinic radiation-curable composition on the surface of an intermediate transfer member onto which a pre-coating liquid has been applied is transferred from the intermediate transfer member to a recording medium. The method for applying a pre-coating liquid and the method for forming an intermediate image are not particularly limited. A publicly known method such as spray coating, dipping, screen printing, gravure printing, offset printing, or an inkjet method can be employed.

The actinic radiation refers to energy rays that polymerize and cross-link an actinic radiation-polymerizable compound contained in the actinic radiation-curable composition to cure the actinic radiation-curable composition. Examples of the actinic radiation include ultraviolet rays, electron beams, α-rays, γ-rays, and X-rays. From the viewpoint of achieving safety and causing the polymerization and cross-linking with low energy, the actinic radiation is preferably ultraviolet rays or electron beams.

The actinic radiation-curable composition refers to a composition that cures through irradiation with actinic radiation. The actinic radiation-curable composition is preferably a liquid composition. The actinic radiation-curable composition is, for example, a publicly known actinic radiation-curable composition, in particular, a publicly known actinic radiation-curable inkjet ink.

### 2. Image Forming Method

A second embodiment of the present invention relates to an image forming method that uses the intermediate transfer member according to the first embodiment.

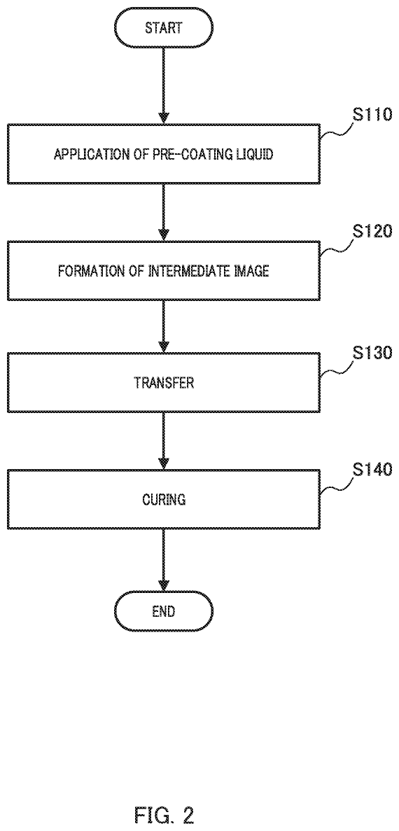

FIG. 2 is a flowchart illustrating an image forming method according to this embodiment. The image forming method includes a step of applying a pre-coating liquid onto an intermediate image surface of the intermediate transfer member (step S110), a step of forming an intermediate image by applying an actinic radiation-curable composition onto the intermediate image surface onto which the pre-coating liquid has been applied (step S120), a step of transferring the formed intermediate image onto a recording medium (step S130), and a step of curing the actinic radiation-curable composition by irradiating the transferred intermediate image with actinic radiation (step S140).

In the step of applying a pre-coating liquid (step S110), a pre-coating liquid is applied onto an intermediate image surface of the intermediate transfer member.

The method for applying a pre-coating liquid is not particularly limited. For example, a method that uses a roll coater, a bar coater, or the like and an inkjet method can be employed.

The pre-coating liquid is applied onto an intermediate image surface and optionally smoothened with a scraper or the like to form a pre-coating layer in contact with the intermediate image surface. From the viewpoint of suppressing the deterioration of transferability caused when an actinic radiation-curable composition to be impacted in the downstream process sinks (infiltrates) into the pre-coating layer, the thickness of the pre-coating layer is preferably smaller than the thickness of an actinic radiation-curable composition in an intermediate image to be formed and can be set to, for example, 0.5 μm or more and 1.0 μm or less.

From the viewpoint of improving the releasability of an actinic radiation-curable composition in the transfer step (step S130) described later, the pre-coating liquid is preferably a liquid having a higher surface tension. On the other hand, from the viewpoint of more sufficiently spreading the pre-coating liquid over the intermediate image surface, the pre-coating liquid is preferably a liquid whose surface tension is not excessively high. From the above viewpoints, the surface tension of the pre-coating liquid is preferably 30 mN/m or more and 70 mN/m or less, more preferably 35 mN/m or more and 60 mN/m or less, and further preferably 40 mN/m or more and 60 mN/m or less.

The surface tension can be a value r determined from r=F/(L cos θ), where F (unit: mN) represents a force required to hold a platinum plate at a position at which a lower end of the platinum plate held in a vertical direction is brought into contact with a pre-coating liquid at 23° C., L (unit: m) represents a perimeter of the platinum plate in contact with the pre-coating liquid, and θ represents a contact angle between the platinum plate and the pre-coating liquid.

A liquid component such as water or a water-soluble organic solvent can be used as the pre-coating liquid. The pre-coating liquid may contain an adjuster for adjusting the surface tension and the viscosity.

Examples of the water-soluble organic solvent include glycols, polyalkylene glycols, glycerol, and polymers and copolymers of the foregoing.

Examples of the adjuster include surfactants and hydrophilic polymers.

In the step of forming an intermediate image (step S120), the actinic radiation-curable composition is applied onto a surface of the pre-coating liquid that has been applied onto the intermediate image surface, thereby forming an intermediate image.

The method for applying an actinic radiation-curable composition is not particularly limited. A publicly known method such as spray coating, dipping, screen printing, gravure printing, offset printing, or an inkjet method can be employed. Among them, an inkjet method is preferred because a higher-definition image can be easily formed.

In the transfer step onto a recording medium (step S130), the formed intermediate image is transferred onto a surface of a recording medium. For example, it is sufficient that an intermediate image surface of the intermediate transfer member on which the intermediate image has been formed is brought into contact with a surface of a recording medium on which an image is to be formed, and pressure is applied from the intermediate transfer member toward the recording medium.

In the step of completely curing the actinic radiation-curable composition (step S140), the actinic radiation-curable composition of the intermediate image that has been transferred onto a recording medium is irradiated with actinic radiation to completely cure the intermediate image. Thus, an image is formed on the recording medium.

The image forming method may also include, between the step of forming an intermediate image (step S120) and the transfer step onto a recording medium (step S130), a step of increasing the viscosity of the formed intermediate image.

The increase in viscosity can be performed by a method in which the intermediate image surface on which the intermediate image has been formed is irradiated with actinic radiation to the degree that the actinic radiation-curable composition is not completely cured. The dose of the actinic radiation can be set to, for example, 5% or more and 40% or less relative to the dose (light quantity) of actinic radiation required to cure the actinic radiation-curable composition used for image formation.

### 3. Image Forming Apparatus

A third embodiment of the present invention relates to an image forming apparatus including the intermediate transfer member according to the first embodiment.

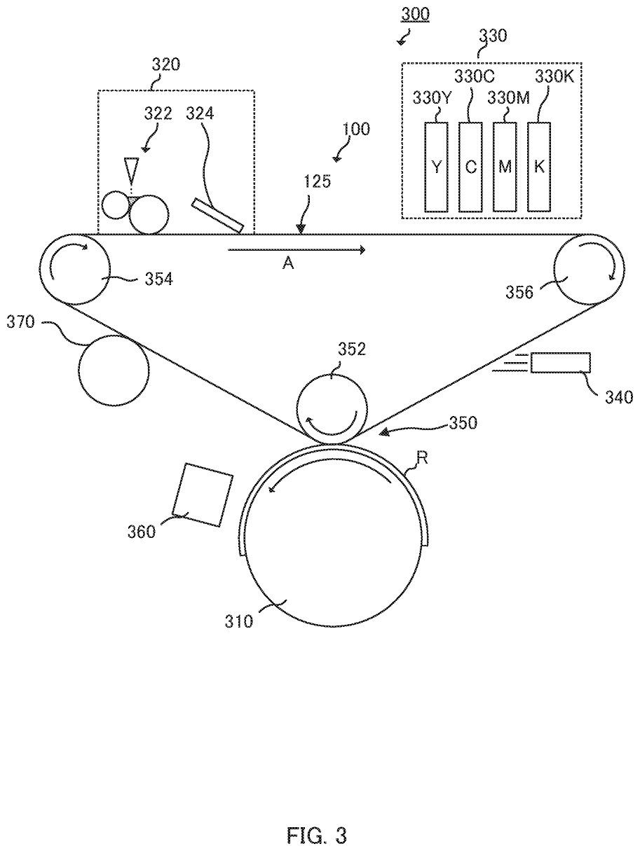

FIG. 3 is a schematic view illustrating an exemplary configuration of image forming apparatus 300 according to this embodiment. Image forming apparatus 300 includes conveyance path 310 through which recording medium R is conveyed, intermediate transfer member 100 according to the first embodiment that is disposed so as to face a surface of conveyance path 310 on which recording medium R is conveyed, pre-coating liquid applying unit 320 configured to apply a pre-coating liquid onto an intermediate image surface of intermediate transfer member 100, intermediate image forming unit 330 configured to form an intermediate image by applying an actinic radiation-curable composition onto the intermediate image surface of intermediate transfer member 100 onto which the pre-coating liquid has been applied, viscosity increasing unit 340 configured to increase the viscosity of the actinic radiation-curable composition by irradiating a surface of the intermediate transfer member with actinic radiation, transfer section 350 configured to transfer the intermediate image containing the actinic radiation-curable composition whose viscosity has been increased onto a recording medium, and curing unit 360 configured to irradiate the surface of conveyance path 310 with actinic radiation used to cure (completely cure) the actinic radiation-curable composition constituting the intermediate image. Image forming apparatus 300 further includes support rollers 352, 354, and 356 configured to stretch intermediate transfer member 100 having an endless belt shape and cleaning unit 370 configured to remove, from the surface of intermediate transfer member 100, the actinic radiation-curable composition left on the surface of intermediate transfer member 100 without being transferred onto recording medium R.

Conveyance path 310 is formed of, for example, a metallic drum and is used to convey recording medium R onto which the intermediate image is transferred. Conveyance path 310 is disposed so as to be partly in contact with the surface of intermediate transfer member 100. The surface of intermediate transfer member 100 in contact with conveyance path 310 is pressurized by support roller 352, thereby forming a transfer nip. Conveyance path 310 may include nails (not illustrated) configured to fix the leading end of recording medium R. Conveyance path 310 includes the nails at which the leading end of recording medium R is fixed and rotates in a counterclockwise direction in FIG. 3, thereby conveying recording medium R to the transfer nip.

Intermediate transfer member 100 is the intermediate transfer member according to the first embodiment. Intermediate transfer member 100 is stretched by support rollers 352, 354, and 356 and rotates in an A direction in the drawing. Thus, intermediate transfer member 100 conveys an intermediate image formed on the surface of intermediate transfer member 100 by intermediate image forming unit 330 to transfer section 350. Intermediate transfer member 100 is disposed so that intermediate image surface 125 faces outward (on the side that faces pre-coating liquid applying unit 320, intermediate image forming unit 330, viscosity increasing unit 340, and conveyance path 310).

Pre-coating liquid applying unit 320 includes roll coater 322 whose surface is coated with a sponge and scraper 324. Roll coater 322 is configured to apply a pre-coating liquid on the intermediate image surface side of intermediate transfer member 100. Scraper 324 is configured to smoothen a surface of the applied pre-coating liquid by removing an excessive amount of pre-coating liquid to form, on a surface of intermediate transfer member 100 on which ink impacts, a pre-coating layer constituted by a pre-coating liquid that spreads out with a particular thickness. Pre-coating liquid applying unit 320 may apply a pre-coating liquid by, for example, a method using a bar coater or an inkjet method.

Any of the above forms may be employed as long as pre-coating liquid applying unit 320 can uniformly apply a pre-coating liquid having the following physical properties onto the intermediate image surface.

From the viewpoint of improving the releasability of an actinic radiation-curable composition in transfer section 350 described later, the pre-coating liquid is preferably a liquid having a higher surface tension. On the other hand, from the viewpoint of more sufficiently spreading the pre-coating liquid over the intermediate image surface, the pre-coating liquid is preferably a liquid whose surface tension is not excessively high. From the above viewpoints, the surface tension of the pre-coating liquid is preferably 30 mN/m or more and 70 mN/m or less, more preferably 35 mN/m or more and 60 mN/m or less, and further preferably 40 mN/m or more and 60 mN/m or less.

Intermediate image forming unit 330 is an ink applying unit configured to form an intermediate image by an inkjet method in this embodiment. Intermediate image forming unit 330 includes inkjet heads 330Y, 330M, 330C, and 330K that respectively discharge actinic radiation-curable compositions (inkjet inks) of Y (yellow), M (magenta), C (cyan), and K (black) through nozzles so that the actinic radiation-curable compositions impact on the surface of intermediate transfer member 100. Inkjet heads 330Y, 330M, 330C, and 330K each cause the actinic radiation-curable composition (ink) to impact on the surface of intermediate transfer member 100 at a position determined in accordance with an image to be formed, thereby forming an intermediate image.

Viscosity increasing unit 340 is configured to apply actinic radiation to intermediate image surface 125 of intermediate transfer member 100 before the intermediate image formed by intermediate image forming unit 330 is conveyed to transfer section 350. The applied actinic radiation enters the actinic radiation-curable composition constituting the intermediate image and increases the viscosity of (temporarily cures) the actinic radiation-curable composition.

It is sufficient that viscosity increasing unit 340 applies actinic radiation to intermediate image surface 125 to the degree that the actinic radiation-curable composition is not completely cured. The dose of the actinic radiation can be set to, for example, 5% or more and 40% or less relative to the dose (light quantity) of actinic radiation required to cure the actinic radiation-curable composition used for image formation.

Transfer section 350 is a section including a transfer nip at which intermediate transfer member 100 and conveyance path 310 come closest to each other. The surface of conveyance path 310 in contact with intermediate transfer member 100 is pressurized by urging intermediate transfer member 100 in a direction toward conveyance path 310 using support roller 352. The intermediate image that has been conveyed while formed on the surface of intermediate transfer member 100 and that contains the actinic radiation-curable composition whose viscosity has been increased by viscosity increasing unit 340 is brought into contact with, at the transfer nip, recording medium R that has been conveyed while disposed on the surface of conveyance path 310. The intermediate image is transferred onto the recording medium by applying pressure from intermediate transfer member 100 toward conveyance path 310 by support roller 352.

Curing unit 360 is disposed downstream of transfer section 350 in a direction in which recording medium R is conveyed through conveyance path 310 and is configured to apply actinic radiation to the surface of conveyance path 310. Thus, curing unit 360 cures (completely cures) the actinic radiation-curable composition constituting the intermediate image by irradiating, with actinic radiation, the actinic radiation-curable composition constituting the intermediate image that has been transferred onto recording medium R. Consequently, a desired image is formed on the surface of recording medium R.

Cleaning unit 370 is a cleaning roller such as a web roller or a sponge roller, and comes into contact with the surface of intermediate transfer member 100 on the downstream side of transfer section 350. Cleaning unit 370 is configured to remove, through rotation of the cleaning roller, a residual composition (residual coating) left on the surface of intermediate transfer member 100 without being transferred onto recording medium R in transfer section 350.

In the above description, the intermediate image is formed on the surface of the intermediate transfer member by an inkjet method, but the method for forming an intermediate image is not particularly limited. A publicly known method such as spray coating, dipping, screen printing, gravure printing, or offset printing can be employed. Among these methods, when an image is formed by an inkjet method in which collapse of ink droplets is more likely to occur because such an image is formed through a combination of dots constituted by droplets of the actinic radiation-curable composition, the above-described image forming apparatus produces a considerable effect of suppressing collapse of ink.

### 4. Actinic Radiation-Curable Composition

The actinic radiation-curable composition is not particularly limited. For example, a publicly known actinic radiation-curable composition (inkjet ink) used for forming an image by an inkjet method may be employed.

### 4-1. Material for Actinic Radiation-Curable Composition

For example, the actinic radiation-curable composition may contain an actinic radiation-polymerizable compound polymerized or cross-linked through irradiation with actinic radiation and optionally a photopolymerization initiator.

The actinic radiation-curable composition may further optionally contain, for example, a colorant such as a dye or a pigment, a dispersant for dispersing a pigment, a fixing resin for fixing a pigment on a substrate, a surfactant, a polymerization inhibitor, a pH adjuster, a humectant, an ultraviolet absorber, or a gelling agent for subjecting the composition to sol-gel phase transition through temperature change. The composition may contain only one of the other components or two or more of the other components.

Examples of the actinic radiation-polymerizable compound include radical polymerizable compounds and cationic polymerizable compounds. The actinic radiation-polymerizable compound may be any of monomers, polymerizable oligomers, prepolymers, and mixtures of the foregoing.

The radical polymerizable compound is preferably an unsaturated carboxylate compound and more preferably a (meth)acrylate. In this specification, “(meth)acrylate” refers to acrylate or methacrylate, “(meth)acryl” refers to acryl or methacryl, and “(meth)acryloyl” refers to acryloyl or methacryloyl.

Examples of monofunctional (meth)acrylates include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinic acid, 2-(meth)acryloyloxyethyl phthalic acid, 2-(meth)acryloyloxyethyl-2-hydroxyethyl-phthalic acid, and t-butylcyclohexyl (meth)acrylate.

Examples of polyfunctional (meth)acrylates include difunctional (meth)acrylates such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-PO adduct di(meth)acrylate, hydroxypivalic acid neopentyl glycol di(meth)acrylate, polytetramethylene glycol di(meth)acrylate, polyethylene glycol diacrylate, and tripropylene glycol diacrylate; and tri- or higher functional (meth)acrylates such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glyceryl propoxy tri(meth)acrylate, and pentaerythritolethoxy tetra(meth)acrylate.

The radical polymerizable compound preferably contains a (meth)acrylate modified with ethylene oxide or propylene oxide (hereafter also simply referred to as a “modified (meth)acrylate”). The modified (meth)acrylate has higher photosensitivity. The modified (meth)acrylate is more compatible with other composition components even at high temperature. Furthermore, the modified (meth)acrylate has a low cure shrinkage, and thus curling of printed matter during image formation is suppressed.

Examples of the cationic polymerizable compound include epoxy compounds, vinyl ether compounds, and oxetane compounds.

Examples of the epoxy compound include alicyclic epoxy resins such as 3,4-epoxycyclohexylmethyl-3′,4′-epoxycyclohexane carboxylate, bis(3,4-epoxycyclohexylmethyl) adipate, vinylcyclohexene monoepoxide, ε-caprolactone-modified 3,4-epoxycyclohexylmethyl-3′,4′-epoxycyclohexane carboxylate, 1-methyl-4-(2-methyloxiranyl)-7-oxabicyclo[4,1,0]heptane, 2-(3,4-epoxycyclohexyl-5,5-spiro-3,4-epoxy) cyclohexanone-meta-dioxane, and bis(2,3-epoxycyclopentyl)ether; aliphatic epoxy compounds such as 1,4-butanediol diglycidyl ether, 1,6-hexanediol diglycidyl ether, glycerol triglycidyl ether, trimethylolpropane triglycidyl ether, polyethylene glycol diglycidyl ether, propylene glycol diglycidyl ether, and polyglycidyl ether of polyether polyol obtained by adding one or more alkylene oxides (e.g., ethylene oxide and propylene oxide) to aliphatic polyhydric alcohols such as ethylene glycol, propylene glycol, and glycerol; and aromatic epoxy compounds such as diglycidyl or polyglycidyl ether of bisphenol A or bisphenol A-alkylene oxide adduct, diglycidyl or polyglycidyl ether of hydrogenated bisphenol A or hydrogenated bisphenol A-alkylene oxide adduct, and novolac epoxy resins.

Examples of the vinyl ether compound include monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether; and di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

Examples of the oxetane compound include 3-hydroxymethyl-3-methyloxetane, 3-hydroxymethyl-3-ethyloxetane, 3-hydroxymethyl-3-propyloxetane, 3-hydroxymethyl-3-n-butyloxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyloxetane, 1,4-bis{[(3-ethyl-3-oxetanyl)methoxy]methyl}benzene, 3-ethyl-3-(2-ethylhexyl)oxymethyl)oxetane, and di[1-ethyl(3-oxetanyl)]methyl ether.

The content of the actinic radiation-polymerizable compound can be set to, for example, 1.0 mass % or more and 97 mass % or less and is preferably 30 mass % or more and 90 mass % or less relative to the total mass of the actinic radiation-curable composition.

The photopolymerization initiator may be any photopolymerization initiator as long as the polymerization of the actinic radiation-polymerizable compound can be initiated. For example, when the actinic radiation-curable composition contains a radical polymerizable compound, the photopolymerization initiator may be a photo-radical initiator. When the actinic radiation-curable composition contains a cationic polymerizable compound, the photopolymerization initiator may be a photo-cationic initiator (photoacid generator).

The content of the photopolymerization initiator can be set to any content as long as the actinic radiation-curable composition is sufficiently cured through irradiation with actinic radiation and the dischargeability of the actinic radiation-curable composition is not deteriorated. For example, the content of the photopolymerization initiator is 0.1 mass % or more and 20 mass % or less and preferably 1.0 mass % or more and 12 mass % or less relative to the total mass of the actinic radiation-curable composition. In the case where the actinic radiation-curable composition can be sufficiently cured without a photopolymerization initiator, such as the case where the actinic radiation-curable composition is cured through irradiation with electron beams, the photopolymerization initiator is unnecessary.

Examples of the colorant include dyes and pigments. From the viewpoint of forming an image having high weather resistance, the colorant is preferably a pigment. The pigment can be selected from, for example, yellow pigments, red or magenta pigments, blue or cyan pigments, and black pigments in accordance with, for example, the color of an image to be formed.

Any dispersant may be used as long as the pigment can be sufficiently dispersed. Examples of the dispersant include hydroxy group-containing carboxylates, salts of long-chain polyaminoamide and high-molecular-weight acid ester, salts of high-molecular-weight polycarboxylic acid, salts of long-chain polyaminoamide and polar acid ester, high-molecular-weight unsaturated acid esters, high-molecular-weight copolymers, modified polyurethanes, modified polyacrylates, polyether ester anionic activators, naphthalenesulfonic acid formalin condensates, aromatic sulfonic acid formalin condensates, polyoxyethylene alkyl phosphates, polyoxyethylene nonyl phenyl ether, and stearylamine acetate.

The content of the dispersant can be set to, for example, 20 mass % or more and 70 mass % or less relative to the total mass of the pigment.

Examples of the fixing resin include (meth)acrylic resins, epoxy resins, polysiloxane resins, maleic acid resins, vinyl resins, polyamide resins, nitrocellulose, cellulose acetate, ethyl cellulose, ethylene-vinyl acetate copolymers, urethane resins, polyester resins, and alkyd resins.

The content of the fixing resin can be set to, for example, 1.0 mass % or more and 10.0 mass % or less relative to the total mass of the actinic radiation-curable composition.

Examples of the surfactant include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkyl allyl ethers, acetylene glycols, and polyoxyethylene.polyoxypropylene block copolymers; cationic surfactants such as alkylamine salts and quaternary ammonium salts; silicone surfactants; and fluoro surfactants.

The content of the surfactant is preferably 0.001 mass % or more and less than 5.0 mass % relative to the total mass of the actinic radiation-curable composition.

Examples of the gelling agent include ketone wax, ester wax, petroleum wax, vegetable wax, animal wax, mineral wax, hydrogenated castor oil, modified wax, higher fatty acid, higher alcohol, hydroxystearic acid, fatty acid amides such as N-substituted fatty acid amide and special fatty acid amide, higher amine, sucrose ester of fatty acid, synthetic wax, dibenzylidene sorbitol, dimer acid, and dimer diol. Among them, from the viewpoint of further improving the pinning properties of a composition (ink), ketone wax, ester wax, higher fatty acid, higher alcohol, and fatty acid amide are preferably used. More preferably, a ketone wax or an ester wax in which the number of carbon atoms of each of carbon chains positioned on both sides of a keto group or an ester group is 9 or more and 25 or less is used.

The content of the gelling agent is preferably 1.0 mass % or more and 10.0 mass % or less relative to the total mass of the actinic radiation-curable composition.

### 4-2. Physical Properties of Actinic Radiation-Curable Composition

From the viewpoint of further improving the ejectability from the inkjet heads, when the actinic radiation-curable composition (inkjet ink) is an ink not containing a gelling agent, the viscosity of the actinic radiation-curable composition at 40° C. is preferably 3 mPa·s or more and 20 mPa·s or less. When the actinic radiation-curable composition is an ink containing a gelling agent, the viscosity of the actinic radiation-curable composition at 80° C. is preferably 3 mPa·s or more and 20 mPa·s or less.

When the actinic radiation-curable composition (inkjet ink) contains a gelling agent, the actinic radiation-curable composition preferably has a phase transition temperature of 40° C. or higher and 70° C. or lower at which the actinic radiation-curable composition undergoes sol-gel phase transition. When the phase transition temperature of the actinic radiation-curable composition is 40° C. or higher, the viscosity of the actinic radiation-curable composition increases immediately after the impact on the substrate, and thus the degree of spreading is more easily controlled. When the phase transition temperature of the actinic radiation-curable composition is 70° C. or lower, the actinic radiation-curable composition does not readily undergo gelation when ejected from ejection heads normally having a composition temperature of about 80° C. Therefore, the actinic radiation-curable composition can be more stably ejected.

The viscosity of the actinic radiation-curable composition at 40° C. and the viscosity and phase transition temperature at 80° C. can be determined by measuring a change in dynamic viscoelasticity of the composition with temperature using a rheometer. In this specification, the viscosity and the phase transition temperature are determined by the following method. The actinic radiation-curable composition is heated to 100° C. and cooled to 20° C. at a shear rate of 11.7 (1/s) and a cooling rate of 0.1° C./s while the viscosity is measured with a stress-controlled rheometer (manufactured by Anton Paar, Physica MCR301 (diameter of cone plate: 75 mm, cone angle: 1.0°)). Thus, a viscosity-temperature curve is obtained. The viscosity at 80° C. and the viscosity at 25° C. are determined by reading the viscosities at 40° C. and 80° C. on the viscosity-temperature curve, respectively. The phase transition temperature is determined as a temperature at which the viscosity is 200 mPa·s on the viscosity-temperature curve.

### EXAMPLES

Hereafter, specific examples of the present invention will be described together with comparative examples, but the present invention is not limited thereto.

### 1. Production of Intermediate Transfer Member

### 1-1. Production of Substrate

A dried, oxidized carbon black (SPECIAL BLACK 4 (manufactured by Degussa, pH 3.0, volatile content: 14.0%)) was added to an N-methyl-2-pyrrolidone (NMP) solution (manufactured by Ube Industries, Ltd., U-varnish S (solid content 18 mass %)) of polyamic acid obtained by reacting 3,3′,4,4′-biphenyltetracarboxylic dianhydride (BPDA) and p-phenylenediamine (PDA). Thus, a mixture was obtained. The oxidized carbon black was added in an amount of 23 parts by mass relative to 100 parts by mass of the solid content of a polyimide resin obtained from the above polyamic acid. The obtained mixture was mixed using a collision-type disperser (Geanus PY manufactured by Geanus) by being passed five times through a path in which the mixture was divided into two parts, caused to collide, and then divided into two parts again at a pressure of 200 MPa and a minimum area of 1.4 mm². Thus, a carbon black-containing polyamic acid solution was obtained.

The carbon black-containing polyamic acid solution was applied onto an inner surface of a cylindrical mold through a dispenser while the cylindrical mold was rotated at 30 rpm for 15 minutes so that a cylindrical layer having a uniform thickness of 0.5 mm was formed. Subsequently, hot air at 60° C. was sent for 30 minutes to the outside of the mold onto which the carbon black-containing polyamic acid solution was applied while the mold was rotated at 15 rpm, and then heating was performed at 150° C. for 60 minutes. Furthermore, the mold was heated to 360° C. at a heating rate of 2° C./min and further heated at 360° C. for 30 minutes to remove the solvent and water resulting from cyclodehydration. Thus, an imide conversion reaction was completed. Then, the mold was cooled to room temperature, and the cylindrical layer was removed from the mold to produce an endless belt type substrate having a total thickness of 0.1 mm.

### 1-2. Production of Elastic Layer

An A liquid and a B liquid of a liquid silicone rubber (manufactured by Shin-Etsu Chemical Co., Ltd., KE-2060-30) were mixed in equal amounts to obtain a liquid silicone rubber solution. The liquid silicone rubber solution was supplied to the outer surface of the produced endless belt type substrate in a helical manner through a dispenser while the substrate was rotated at 1 rpm so that a layer having a thickness of 0.5 mm was formed. Hot air at 120° C. was sent to the substrate for 5 minutes while the substrate was continuously rotated to perform primary curing. Subsequently, the substrate was heated to 200° C. and then heated for 60 minutes to produce an endless belt with an elastic layer.

### 1-3. Preparation of Surface-Treating Solution

### 1-3-1. Preparation of Surface-Treating Solution a

A solution having a pH of 4 adjusted by adding acetic acid to ion-exchanged water was provided. Two parts by mass of 2-[methoxy(polyethyleneoxy)6-9propyl]trimethoxysilane (manufactured by Gelest, SIM6492.7) serving as a surface-treating agent having a hydrophilic functional group was slowly added dropwise to 100 parts by mass of the above solution, and stirring was performed for 1 hour. Surface-treating solution A was obtained through confirmation of complete dissolution of the surface-treating agent.

### 1-3-2. Preparation of Surface-Treating Solution B

Surface-treating solution B was obtained in the same manner as in the preparation of surface-treating solution A, except that the surface-treating agent was changed to [hydroxy(polyethyleneoxy)propyl]triethoxysilane (manufactured by Gelest, SIH6188.0) serving as a surface-treating agent having a hydrophilic functional group.

### 1-3-3. Preparation of Surface-Treating Solution C

Twenty parts by mass of a betaine polymer-type silane (manufactured by OSAKA ORGANIC CHEMICAL INDUSTRY Ltd., LAMBIC-771W) serving as a surface-treating agent having a hydrophilic functional group was slowly added dropwise to 80 parts by mass of ion-exchanged water, and stirring was performed for 1 minute to obtain surface-treating solution C.

### 1-3-4. Preparation of Surface-Treating Solution D

Surface-treating solution D was obtained in the same manner as in the preparation of surface-treating solution A, except that the surface-treating agent was changed to glycidoxypropyltrimethoxysilane (manufactured by Shin-Etsu Chemical Co., Ltd., KBM-403) serving as a surface-treating agent having a hydrophilic functional group.

### 1-3-5. Preparation of Surface-Treating Solution E

Surface-treating solution E was obtained in the same manner as in the preparation of surface-treating solution A, except that the surface-treating agent was changed to methylhydrogenpolysiloxane (manufactured by Shin-Etsu Chemical Co., Ltd., KF-9901) serving as a surface-treating agent not having a hydrophilic functional group.

### 1-3-6. Preparation of Surface-Treating Solution F

Surface-treating solution F was obtained in the same manner as in the preparation of surface-treating solution A, except that the surface-treating agent was changed to methyltrimethoxysilane (manufactured by Shin-Etsu Chemical Co., Ltd., KBM-13) serving as a surface-treating agent not having a hydrophilic functional group.

### 1-4. Production of Intermediate Transfer Member

### 1-4-1. Production of Intermediate Transfer Member 1

The endless belt with an elastic layer was subjected to corona discharging treatment under conditions of 350 mW using a corona treater (manufactured by KASUGA DENKI, Inc.) while the endless belt was rotated at 100 mm/s.

Immediately after the corona discharging, surface-treating solution A was applied using a spray nozzle so that the entire belt surface was wetted, and was dried by heating at 120° C. for 60 minutes. Subsequently, the belt surface was washed with ion-exchanged water, then dried, and aged for 12 hours to produce intermediate transfer member 1.

### 1-4-2. Production of Intermediate Transfer Member 2

Intermediate transfer member 2 was produced in the same manner as in the production of intermediate transfer member 1, except that surface-treating solution B was used instead of surface-treating solution A.

### 1-4-3. Production of Intermediate Transfer Member 3

Intermediate transfer member 3 was produced in the same manner as in the production of intermediate transfer member 1, except that surface-treating solution C was used instead of surface-treating solution A.

### 1-4-4. Production of Intermediate Transfer Member 4

Intermediate transfer member 4 was produced in the same manner as in the production of intermediate transfer member 1, except that surface-treating solution D was used instead of surface-treating solution A.

### 1-4-5. Production of Intermediate Transfer Member 5

One hundred parts by mass of chloroprene rubber (manufactured by Denka Company Limited, M-30), 5 parts by mass of zinc white, 4 parts by mass of magnesium oxide, 1 part by mass of stearic acid, 10 parts by mass of naphthenic process oil, and 1 part by mass of a vulcanization accelerator (SANCELER 22-C) were dissolved in 300 parts by mass of toluene to obtain a chloroprene rubber solution. The chloroprene rubber solution was supplied to the outer surface of the endless belt type substrate in a helical manner through a dispenser while the substrate was rotated at 1 rpm so that a layer having a thickness of 2.5 mm was formed. Hot air at 120° C. was sent to the substrate for 30 minutes while the substrate was continuously rotated to perform drying and curing. Subsequently, the substrate was heated to 200° C. and then heated for 60 minutes to produce an endless belt with an elastic layer. Subsequently, intermediate transfer member 5 was produced in the same manner as in the production of intermediate transfer member 1.

### 1-4-6. Production of Intermediate Transfer Member 6

Intermediate transfer member 6 was produced in the same manner as in the production of intermediate transfer member 1, except that the elastic layer was not formed.

### 1-4-7. Production of Intermediate Transfer Member 7

Intermediate transfer member 7 was produced in the same manner as in the production of intermediate transfer member 4, except that the elastic layer was not formed.

### 1-4-8. Production of Intermediate Transfer Member 8

Intermediate transfer member 8 was produced in the same manner as in the production of intermediate transfer member 1, except that surface-treating solution E was used instead of surface-treating solution A.

### 1-4-9. Production of Intermediate Transfer Member 9

Intermediate transfer member 9 was produced in the same manner as in the production of intermediate transfer member 1, except that surface-treating solution F was used instead of surface-treating solution A.

### 1-4-10. Production of Intermediate Transfer Member 10

Intermediate transfer member 10 was produced in the same manner as in the production of intermediate transfer member 1, except that surface-treating solution A was not applied after the corona discharging treatment.

### 1-4-11. Production of Intermediate Transfer Member 11

Intermediate transfer member 11 was produced in the same manner as in the production of intermediate transfer member 1, except that neither of the corona discharging treatment nor a surface treatment was performed.

### 1-5. Measurement of Contact Angle

The contact angle of pure water on the surface of each of intermediate transfer member 1 to intermediate transfer member 11 was measured at 20° C. in conformity with JIS R 3257(1999).

### 2. Preparation of Pre-Coating Liquid

### 2-1. Pre-Coating Liquid 1

Polyethylene glycol (manufactured by Sanyo Chemical Industries, Ltd., PEG-200) was used as pre-coating liquid 1.

### 2-2. Pre-Coating Liquid 2

Polypropylene glycol (manufactured by Sanyo Chemical Industries, Ltd., NEWPOL PP-200) was used as pre-coating liquid 2.

### 2-3. Pre-Coating Liquid 3

Polypropylene glycol triol (manufactured by Sanyo Chemical Industries, Ltd., NEWPOL GP-250) was used as pre-coating liquid 3.

### 2-4. Pre-Coating Liquid 4

Glycerol (manufactured by Sakamoto Yakuhin Kogyo Co., Ltd.) was provided as pre-coating liquid 4.

### 2-5. Pre-Coating Liquid 5

Pure water was provided as pre-coating liquid 5.

### 2-6. Surface Tension

The surface tension r of each of pre-coating liquid 1 to pre-coating liquid 5 was determined from r=F/(L cos θ), where F (unit: mN) represents a force required to hold a platinum plate at a position at which a lower end of the platinum plate held in a vertical direction is brought into contact with each of pre-coating liquid 1 to pre-coating liquid 5 at 23° C., L (unit: m) represents a perimeter of the platinum plate in contact with each of pre-coating liquid 1 to pre-coating liquid 5, and 0 represents a contact angle between the platinum plate and each of pre-coating liquid 1 to pre-coating liquid 5.

### 3. Preparation of Actinic Radiation-Curable Composition

The following pigment dispersant, actinic radiation-polymerizable compound, and polymerization inhibitor were inserted into a stainless beaker and heated under stirring using a 65° C. hot plate for 1 hour.

| | |
|---|---|
| Pigment dispersant: AJISPER PB824 | 9 parts by mass |
| (manufactured by Ajinomoto Fine-Techno Co., Inc.) | |

Actinic radiation-polymerizable compound: tripropylene glycol diacrylate 70 parts by mass

Polymerization inhibitor: Irgastab UV10 (manufactured by Ciba Japan K.K.) 0.02 parts by mass

After the mixed solution was cooled to room temperature, 21 parts by mass of Pigment Red 122 (manufactured by Dainichiseika Color & Chemicals Mfg. Co., Ltd., CHROMOFINE RED 6112JC) was added thereto. The mixed solution was inserted into a glass bottle together with 200 g of zirconia beads having a diameter of 0.5 mm and hermetically sealed, and dispersion treatment was performed in a paint shaker for 8 hours. Subsequently, the zirconia beads were removed to produce a pigment dispersion 1.

The following actinic radiation-polymerizable compounds, photopolymerization initiators, polymerization inhibitor, and surfactant and the above pigment dispersion 1 were mixed with each other and heated to 100° C. under stirring. Subsequently, the obtained liquid was hot-filtered with a #3000 metal mesh filter and then cooled to prepare an ink.

| | | |
|---|---|---|
| Actinic radiation-polymerizable compound: | 29.9 | parts by mass |
| polyethylene glycol #400 diacrylate | | |
| Actinic radiation-polymerizable compound: | 15.0 | parts by mass |
| 4EO-modified pentaerythritol tetraacrylate | | |
| Actinic radiation-polymerizable compound: | 23.0 | parts by mass |
| 6EO-modified trimethylolpropane triacrylate | | |
| Photopolymerization initiator: DAROCUR TPO | 6.0 | parts by mass |
| (manufactured by BASF) | | |
| Photopolymerization initiator: ITX (manufactured | 1.0 | part by mass |
| by DKSH Japan) | | |
| Photopolymerization initiator: DAROCUR EDB | 1.0 | part by mass |
| (manufactured by BASF) | | |
| Surfactant: KF-352 (manufactured by Shin- | 0.1 | parts by mass |
| Etsu Chemical Co., Ltd.) | | |
| Gelling agent: distearyl ketone (manufactured | 5.0 | parts by mass |
| by Kao Corporation, KAO WAX T1) | | |
| Pigment dispersion 1: | 19.0 | parts by mass |

### 4. Image Formation and Evaluation

An image was formed under the following conditions using an image forming apparatus having the configuration in FIG. 3.

The pre-coating liquid applying unit included a roll coater whose surface was coated with a sponge and a scraper, and applied any one of pre-coating liquid 1 to pre-coating liquid 5 to form a pre-coating layer.

In the intermediate image forming unit, inkjet heads each including a piezoelectric inkjet head, an ink tank, a supply pipe, a pre-chamber ink tank immediately before a recording head, and a pipe with a filter were used. The inkjet heads disposed were line-head inkjet heads in which piezoelectric heads having a nozzle diameter of 24 μm and a resolution of 512 dpi were arranged in a staggered pattern to achieve a recording resolution of 1200 dpi×1200 dpi. The ink tank communicating with the inkjet head was filled with ink, and 3.5 pl per droplet of ink 1 heated to 80° C. was discharged at a droplet discharge speed of 6 msec to cause ink 1 to impact on the surface of the intermediate transfer member.

The conveyance path was a triple-size transfer metallic drum for printers that holds a recording medium with an air suction chuck and conveys the recording medium.

The curing unit included a UV-LED light source with a wavelength of 395 nm, and the irradiation intensity was 100 mJ/cm².

The recording medium was a coated paper (manufactured by Oji Paper Co., Ltd., OK Top Coat, basis weight 84.9 g/m²) and a non-coated paper (rough paper: manufactured by NIPPON PAPER INDUSTRIES Co., Ltd., NPI wood-free paper, basis weight 81.4 g/m²).

Each of the recording media was conveyed to the image forming apparatus at 600 mm/s, and ten solid images and ten 10% halftone images having a size of 30 cm×30 cm were formed.

Through observation of the obtained solid images and halftone images, the transferability was evaluated based on the following criteria.

A: The transfer ratio is 98% or more.
B: The transfer ratio is 95% or more and less than 98%.
C: The transfer ratio is 90% or more and less than 95%.
D: The transfer ratio is less than 90%.

Table 1 shows the combination of the intermediate transfer member and pre-coating liquid used for the test and the evaluation results.

TABLE 1

| | | Intermediate transfer member | | | | | | Pre-coating | | | |
|---|---|---|---|---|---|---|---|---|---|---|---|
| | | | | | Type of | Functional | | liquid | | | |
| | | | | | surface- | group of | | | Surface | Evaluation | |
| | Test | | | Elastic | treating | surface- | Contact | | tension | Coated | Rough |
| | No. | No. | Substrate | layer | solution | treating agent | angle [°] | No. | [mN/m] | paper | paper |
| Example | 1 | 1 | Polyimide | Silicone | A | Hydrophilicity | 16 | 1 | 45 | A | A |
| | | | film | rubber | | | | | | | |
| Example | 2 | 1 | Polyimide | Silicone | A | Hydrophilicity | 16 | 2 | 33 | A | C |
| | | | film | rubber | | | | | | | |
| Example | 3 | 1 | Polyimide | Silicone | A | Hydrophilicity | 16 | 3 | 38 | A | B |
| | | | film | rubber | | | | | | | |
| Example | 4 | 2 | Polyimide | Silicone | B | Hydrophilicity | 12 | 1 | 45 | A | B |
| | | | film | rubber | | | | | | | |
| Example | 5 | 3 | Polyimide | Silicone | C | Hydrophilicity | 20 | 1 | 45 | A | A |
| | | | film | rubber | | | | | | | |
| Example | 6 | 4 | Polyimide | Silicone | D | Hydrophilicity | 47 | 2 | 33 | B | C |
| | | | film | rubber | | | | | | | |
| Example | 7 | 5 | Polyimide | Chloroprene | A | Hydrophilicity | 16 | 1 | 45 | B | B |
| | | | film | rubber | | | | | | | |
| Example | 8 | 6 | Polyimide | — | A | Hydrophilicity | 16 | 1 | 45 | B | C |
| | | | film | | | | | | | | |
| Example | 9 | 7 | Polyimide | — | D | Hydrophilicity | 47 | 2 | 33 | C | C |
| | | | film | | | | | | | | |
| Example | 10 | 1 | Polyimide | Silicone | A | Hydrophilicity | 16 | 4 | 65 | A | B |
| | | | film | rubber | | | | | | | |
| Example | 11 | 1 | Polyimide | Silicone | A | Hydrophilicity | 16 | 5 | 72 | C | C |
| | | | film | rubber | | | | | | | |
| Comparative | 12 | 8 | Polyimide | Silicone | E | Hydrophobicity | 95 | 1 | 45 | D | D |
| Example | | | film | rubber | | | | | | | |
| Comparative | 13 | 9 | Polyimide | Silicone | F | Hydrophobicity | 63 | 1 | 45 | D | D |
| Example | | | film | rubber | | | | | | | |
| Comparative | 14 | 10 | Polyimide | Silicone | — | | 100 | 1 | 45 | D | D |
| Example | | | film | rubber | | | | | | | |
| Comparative | 15 | 11 | Polyimide | Silicone | — | | 100 | 1 | 45 | D | D |
| Example | | | film | rubber | | | | | | | |

As is clear from the results in Table 1, regardless of the coated paper and rough paper serving as a recording medium, the transferability was better in test No. 1 to test No. 11 in which an image was formed using an intermediate transfer member having an intermediate image surface containing a resin chemically modified with a hydrophilic functional group than in test No. 12 to test No. 15 in which an image was formed using an intermediate transfer member having an intermediate image surface containing a resin not chemically modified with a hydrophilic functional group.

The transferability was better in test No. 1 to test No. 7 in which an image was formed using a multilayer intermediate transfer member including a substrate layer and an elastic layer than in test No. 8 and test No. 9 in which an image was formed using a single-layer intermediate transfer member not including an elastic layer. This may be because the intermediate transfer surface readily follows the projections and depressions of a recording medium during transfer.

The transferability was better in test No. 1 to test No. 6 in which an image was formed using an intermediate transfer member including an elastic layer (uppermost layer) containing silicone rubber than in test No. 7 in which an image was formed using an intermediate transfer member including an elastic layer containing chloroprene rubber. This may be because silicone rubber allows a hydrophilic functional group to be uniformly fixed on the surface of the intermediate transfer member.

The transferability was better in test No. 1 to test No. 5 in which an image was formed using an intermediate transfer member whose intermediate image surface had a pure water contact angle of 40° or less than in test No. 6 in which an image was formed using an intermediate transfer member whose intermediate image surface had a pure water contact angle of 40° or more. This may be because the intermediate image surface has a smaller pure water contact angle and thus a pre-coating liquid having a high surface tension can be sufficiently spread over the intermediate image surface.

### INDUSTRIAL APPLICABILITY

According to the intermediate transfer member of the present invention, the pre-coating liquid capable of improving the releasability of the actinic radiation-curable composition can be sufficiently spread over the surface of the intermediate transfer member to improve the transferability of the actinic radiation-curable composition. In particular, the present invention is suitable for intermediate transfer image formation using an inkjet ink, and is promising for widening the applicability of an image forming method using an inkjet ink and contributing the progress and diffusion of technology in this field.

Although embodiments of the present invention have been described and illustrated in detail, the disclosed embodiments are made for purposes of illustration and example only and not limitation. The scope of the present invention should be interpreted by terms of the appended claims.

What is claimed is:

1. A single-layer or multilayer intermediate transfer member, comprising a surface on which an intermediate image is to be formed, the surface containing a resin chemically modified with a hydrophilic functional group.

2. The intermediate transfer member according to claim 1, wherein the hydrophilic functional group is a functional group selected from the group consisting of an oxyalkylene group having 1 to 3 carbon atoms, a hydroxy group, and an amino group.

3. The intermediate transfer member according to claim 1, wherein the hydrophilic functional group is an ionic functional group.

4. The intermediate transfer member according to claim 1, wherein the hydrophilic functional group is a functional group obtained by modifying the resin with a hydrophilic group-containing silane compound.

5. The intermediate transfer member according to claim 1, wherein the intermediate transfer member is a multilayer intermediate transfer member including a substrate layer and an elastic layer.

6. The intermediate transfer member according to claim 5, wherein the elastic layer contains silicone rubber.

7. The intermediate transfer member according to claim 1, wherein the surface on which an intermediate image is to be formed has a pure water contact angle of 50° or less.

8. The intermediate transfer member according to claim 1, wherein the surface on which an intermediate image is to be formed has a pure water contact angle of 40° or less.

9. The intermediate transfer member according to claim 1, wherein the surface on which an intermediate image is to be formed has a pure water contact angle of 30° or less.

10. The intermediate transfer member according to claim 1, wherein the intermediate transfer member is used for image formation in which the intermediate image is formed by an inkjet method and the intermediate image is transferred onto a recording medium.

11. An image forming method, comprising:
forming an intermediate image on the surface of the intermediate transfer member according to claim 10 by an inkjet method; and
transferring the formed intermediate image onto a recording medium.

12. The image forming method according to claim 11, comprising:
applying a pre-coating liquid onto the surface of the intermediate transfer member,
wherein the intermediate image is formed on the surface onto which the pre-coating liquid is applied.

13. The image forming method according to claim 12, wherein the pre-coating liquid is a pre-coating liquid having a surface tension of 30 mN/m or more and 70 mN/m or less.

14. An image forming apparatus, comprising:
the intermediate transfer member according to claim 10;
an image former that forms an intermediate image on the surface of the intermediate transfer member by an inkjet method; and
a transferer that transfers the formed intermediate image onto a recording medium.

15. The image forming apparatus according to claim 14, comprising:
a pre-coating liquid applier that applies a pre-coating liquid onto the surface of the intermediate transfer member,
wherein the image former forms the intermediate image on the surface onto which the pre-coating liquid is applied.

16. The image forming apparatus according to claim 15, wherein the pre-coating liquid applier applies a pre-coating liquid having a surface tension of 30 mN/m or more and 70 mN/m or less onto the surface of the intermediate transfer member.
